(19) United States
(12) Patent Application Publication
(10) Pub. No.: US 2010/0310266 A1
(43) Pub. Date: Dec. 9, 2010

(54) FUSER FOR IMAGE FORMING APPARATUS AND HEATING CONTROL METHOD

(75) Inventors: Hiroshi NAKAYAMA, Shizuoka (JP); Kazuhiko KIKUCHI, Kanagawa (JP); Satoshi KINOUCHI, Tokyo (JP); Hiroaki YAMAUCHI, Shizuoka (JP); Shuji YOKOYAMA, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/794,095

(22) Filed: Jun. 4, 2010

Related U.S. Application Data
(60) Provisional application No. 61/184,694, filed on Jun. 5, 2009.

(51) Int. Cl. G03G 15/20

(52) U.S. Cl. 399/67

(57) ABSTRACT

Certain embodiments provide a fuser including: a heat roller; a press roller; a coil; an inverter; a driver; a mechanism configured to change a clearance of a gap between a coil and an outer circumferential surface of the heat roller; and a controller. The controller sends information indicating a first power level to the driver. The mechanism changes the clearance to a first distance. The controller sends information indicating a second power level larger than the first power level to the driver. The mechanism changes the clearance to a second distance larger than the first distance.

### CROSS-REFERENCE TO RELATED APPLICATION

The present application claims priority under 35 U.S.C. 119 to U.S. Provisional Application Ser. No. 61/184,694, filed on Jun. 5, 2009, the entire disclosure of which is incorporated herein by reference.

### FIELD

Embodiments described herein relates generally to a fuser, an image forming apparatus, and a heating control method for the fuser.

### BACKGROUND

A reduction in power consumption of a fuser is intended. Fixing performed by using heating by electromagnetic induction realizes high conversion efficiency. The conversion efficiency indicates a ratio of heat to electric power.

The heating apparatus directly heats a heat generating layer. The fuser raises the temperature of a heat roller to fixing temperature. The fuser does not need to use a heat generating layer having a large heat capacity. The conversion efficiency by induction heating is equal to or larger than conversion efficiency by heating of a halogen lamp heater.

The fuser has a coil in the radial direction of the heat roller at a clearance of several millimeters from the outer circumferential surface of the heat roller. The heat roller has a characteristic that the heat roller is thermally expanded by temperature. The fuser has the coil and the heat roller in a container such that the clearance between the coil and the heat roller is within a predetermined range.

The clearance between the coil and the heat roller has an appropriate value with respect to a driving frequency of electric current or voltage.

If the clearance between the coil and the heat roller is fixed in the fuser, the fuser has a driving frequency with inferior conversion efficiency.

The international standard concerning energy saving sets, for a machine such as an MFP (Multi Function Peripheral), plural operation modes of the machine and power consumptions requested in the respective modes.

### DESCRIPTION OF THE DRAWINGS

FIG. 1 is a diagram of an image forming apparatus according to a first embodiment;

FIG. 2A is a diagram of the structure of a fuser according to the first embodiment;

FIG. 2B is a diagram of a layer structure of a heat roller;

FIG. 3A is a disassembled perspective view of the fuser according to the first embodiment;

FIG. 3B is a perspective view of the heat roller and a coil unit;

FIG. 3C is a top view of a coil;

FIGS. 4A and 4B are diagrams of a gap changing mechanism;

FIG. 5A is a block diagram of circuits on an electrical board;

FIG. 5B is a block diagram of an induction heating circuit;

FIG. 6 is a flowchart for explaining a heating control method of the fuser;

FIG. 7A is a sectional view of the heat roller and the coil unit in a state in which the gap changing mechanism narrows a gap;

FIG. 7B is a sectional view of the heat roller and the coil unit in a state in which the gap changing mechanism expands the gap;

FIG. 8A is a disassembled perspective view of a fuser according to a second embodiment;

FIG. 8B is a perspective view of a heat roller and a coil unit;

FIG. 8C is a top view of five coils;

FIG. 8D is a side view of the five coils;

FIG. 9 is a block diagram of an induction heating circuit;

FIG. 10 is a perspective view of a main part of a fuser according to a third embodiment; and

FIG. 11 is a diagram of the arrangement of a fuser according to a fourth embodiment.

### DETAILED DESCRIPTION

Certain embodiments provide a fuser including: a heat roller configured to generate heat with a magnetic flux; a press roller configured to apply pressure to a sheet in cooperation with the heat roller; a coil configured to generate the magnetic flux to the heat roller; an inverter configured to supply a driving signal to the coil; a driver configured to set a power level in the inverter; a mechanism configured to move the coil and change a clearance of a gap between the coil and an outer circumferential surface of the heat roller; and a controller. The controller configured to send information indicating a first power level to the driver to instruct the mechanism to change the clearance to a first distance and send information indicating a second power level larger than the first power level to the driver to instruct the mechanism to change the clearance to a second distance larger than the first distance.

Throughout this description, the embodiments and examples shown should be considered as exemplars, rather than limitations on the apparatus and methods.

A fuser, an image forming apparatus, and a heating control method for the fuser are explained in detail below with reference to the accompanying drawings as examples. In the figures, the same components are denoted by the same reference numerals and signs and redundant explanation of the components is omitted.

### First Embodiment

An image forming apparatus according to a first embodiment is an MFP.

A fuser according to this embodiment is a fuser employing induction heating. The fuser has a mechanism configured to change a clearance of a gap. The gap indicates an air gap between the outer circumferential surface of a heat roller and a coil surface of a coil. The clearance indicates a distance in a heat roller radial direction of the gap.

A heating control method for the fuser according to this embodiment is a method with which the fuser changes the clearance according to power consumption set as a target in the heat roller by an induction heating circuit.

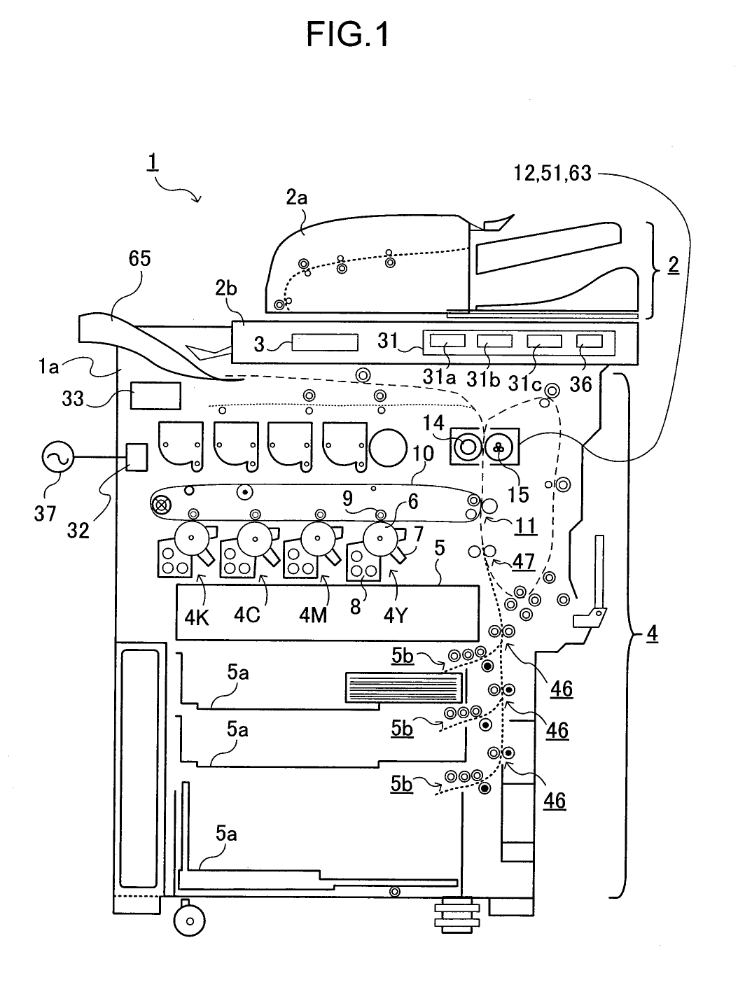

FIG. 1 is a diagram of the MFP. An MFP 1 includes a scanner unit 2 (an image reading unit), an image processing unit 3, and a print unit 4.

The scanner unit 2 scans the surface of an original document to read an image and converts read image information into an analog signal. The scanner unit 2 includes an automatic document feeder 2a and a scanning optical system 2b.

The automatic document feeder 2a conveys the original document onto a document table of glass. The scanning optical system 2b moves a reading position with respect to the document surface from the left to the right. The scanning optical system 2b causes a reflected beam from the document surface to converge on a line sensor.

The image processing unit 3 converts image data of three colors output by the scanner unit 2 into four print color data. The print unit 4 modulates laser beams of four colors respectively with the four print color data. The print unit 4 forms a toner image (a developer image) on a sheet.

The MFP 1 includes plural cassettes 5a in a lower part a machine body 1a. The MFP 1 includes roller pairs 5b in inlets of the cassettes 5a, respectively.

The print unit 4 includes image forming units 4Y, 4M, 4C, and 4K for yellow (Y), magenta (M), cyan (C), and black (K) and a laser exposure device 5.

The image forming unit 4Y includes a photoconductive drum 6, a charger 7, a developing device 8, and a transfer device 9. The photoconductive drum 6 holds a latent image on a photoconductive member. The charger 7 uniformly charges the photoconductive drum 6. The laser exposure device 5 forms a latent image on the photoconductive drum 6.

The developing device 8 develops the latent image on the photoconductive drum 6. The developing device 8 includes a developing roller and a mixer. The transfer device 9 transfers a toner image on the photoconductive drum 6 onto a belt 10. The belt 10 is an intermediate transfer belt.

The configurations of the image forming units 4M, 4C, and 4K are substantially the same as the configuration of the image forming unit 4Y.

The print unit 4 includes a secondary transfer member 11 and a fuser 12. The secondary transfer member 11 includes two roller pairs.

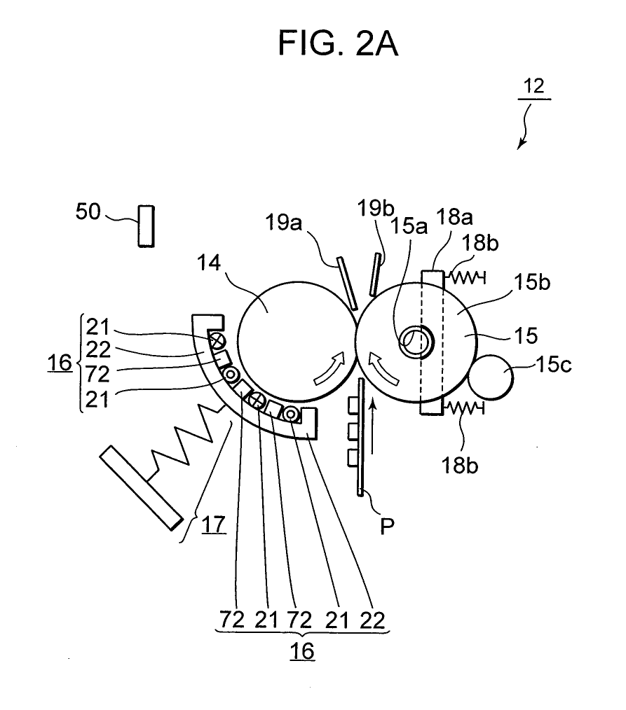

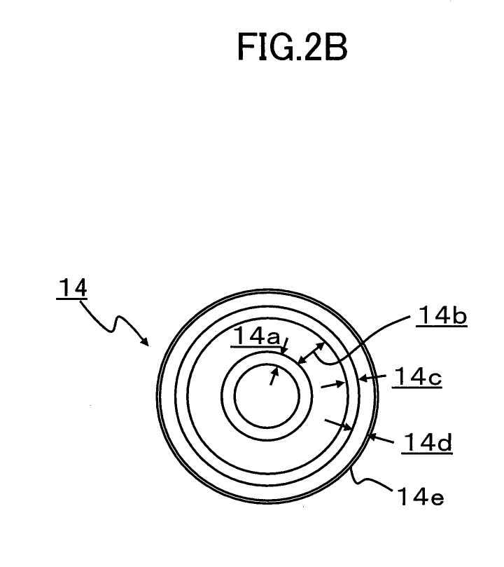

FIG. 2A is a diagram of the structure of the fuser 12. In FIG. 2A, a sectional structure obtained by cutting the fuser 12 along a vertical surface orthogonal to an axis of a heat roller 14 in the center in the axis direction thereof is shown.

The fuser 12 includes a container, the heat roller 14, a press roller 15, a coil unit 16, and a gap changing mechanism 17.

The heat roller 14 and the press roller 15 form a nip. The nip indicates an area formed by contact between the outer circumferential surface of the heat roller 14 and the outer circumferential surface of the press roller 15. The nip has width in the axis direction.

One motor drives one of the heat roller 14 and the press roller 15. One of the heat roller 14 and the press roller 15 drives the other. The heat roller 14 and the press roller 15 rotate in directions indicated by arrows.

Alternatively, one motor drives both of the heat roller 14 and the press roller 15.

The heat roller 14 has a five-layer structure. FIG. 2B is a diagram of the layer structure of the heat roller 14.

Five layers are provided in the following order from the center axis of the heat roller 14 toward the outer circumferential surface thereof: a core bar 14a, a foamed rubber (sponge) 14b, a metal conductive layer 14c as an outer layer of the foamed rubber 14b, a solid rubber layer 14d, and a release layer 14e.

The thickness of the core bar 14a is 2 mm. The thickness of the foamed rubber 14b is 5 mm. The foamed rubber 14b does not come into direct contact with a sheet P. The thickness of the metal conductive layer 14c is 40 μm.

A resistance component of the metal conductive layer 14c generates Joule heat. A material of the metal conductive layer 14c is nickel. Alternatively, the material of the metal conductive layer 14c is stainless steel (SUS) or aluminum. Alternatively, the material of the metal conductive layer 14c is, for example, a composite material of stainless steel and aluminum.

The solid rubber layer 14d contains silicon rubber as an essential component. The thickness of the solid rubber layer 14d is 200 μm.

The release layer 14e is a PFA (perfluoroalkyl-tetrafluoroethylene copolymer) tube. The thickness of the release layer 14e is 30 μm.

The press roller 15 includes a core bar 15a and a rubber layer 15b that covers around the core bar 15a. The rubber layer 15b contains silicon sponge rubber and fluorine rubber as essential components. Reference numeral 15c denotes a cleaning roller.

As shown in FIG. 2A, the core bar 15a comes into contact with a bar 18a. Two springs 18b apply elastic force to the bar 18a. The springs 18b cause force in a direction from the press roller 15 to the heat roller 14 to act on the press roller 15.

The press roller 15 receives the force and comes into contact with the heat roller 14. The fuser 12 holds the heat roller 14 and the press roller 15 spacing the rollers nip width apart from each other.

The fuser 12 causes the sheet P to pass through the nip. The fuser 12 melts a toner on the sheet P and applies pressure to a sheet surface.

The fuser 12 includes blades 19a and 19b. The fuser 12 includes the blades 19a and 19b further on a downstream side in a traveling direction of the sheet P than the nip. An edge of the blade 19a peels the sheet P from the heat roller 14. An edge of the blade 19b peels the sheet P from the press roller 15.

The coil unit 16 is a heating unit. The coil unit 16 includes one coil 21 and a magnetic core 22 (a core). The coil 21 generates a magnetic flux. The coil 21 generates eddy-current in the metal conductive layer 14c.

The magnetic core 22 intensifies concentration of the magnetic flux on the heat roller 14. A material having high magnetic permeability and low loss is used for the magnetic core 22. A ferrite material is used for the magnetic core 22. A shape of the magnetic core 22 is an arch shape on a cut surface orthogonal to the axis.

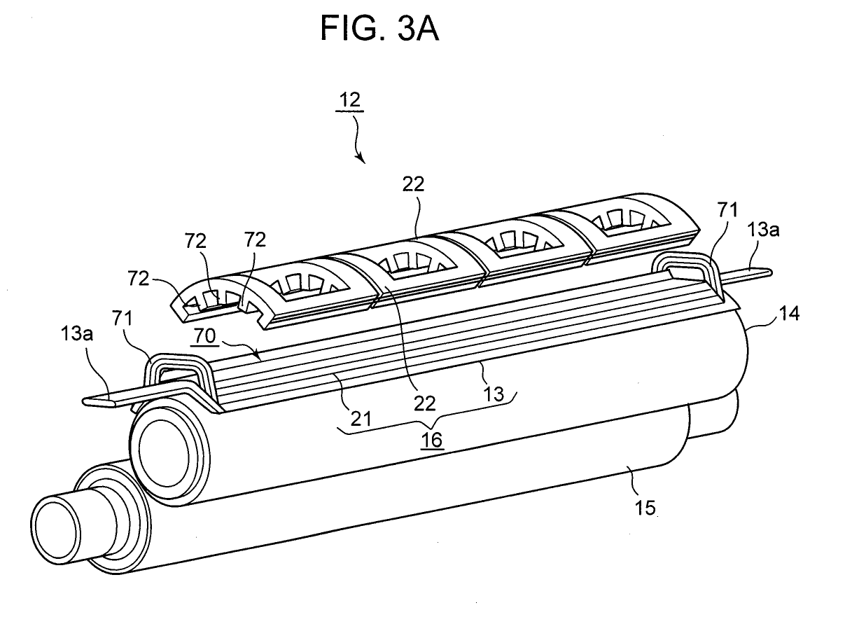

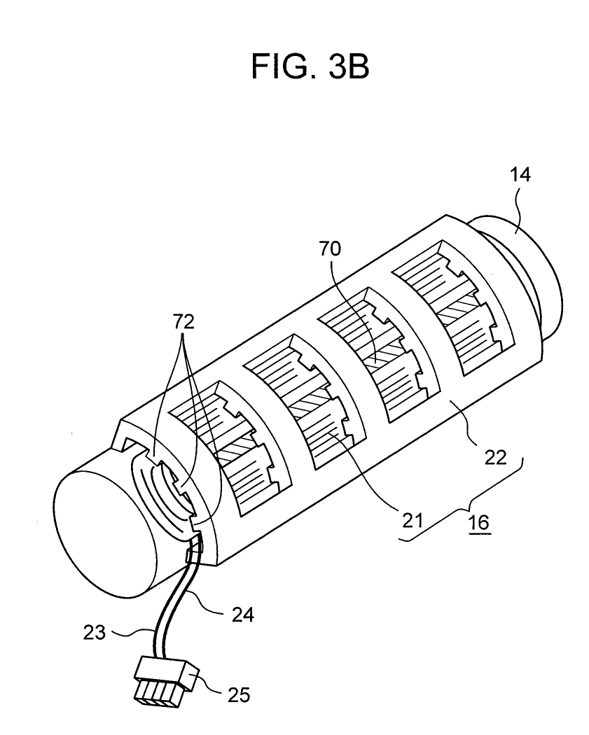

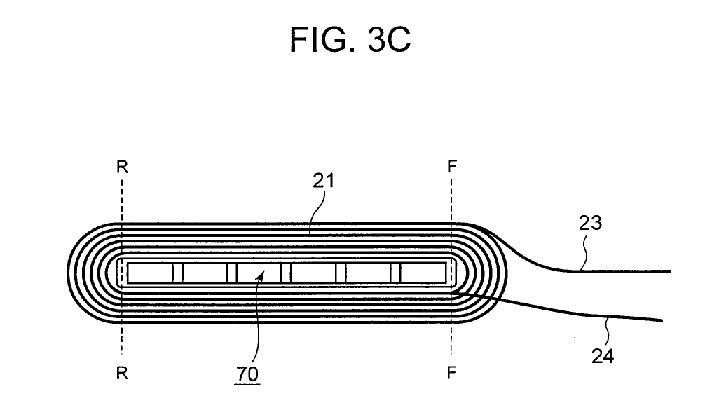

FIG. 3A is a disassembled perspective view of the fuser 12. FIG. 3B is a perspective view of the heat roller 14 and the coil unit 16. FIG. 3C is a top view of the coil 21. In FIGS. 3A to 3C, the same components are denoted by the same reference numerals and signs. Reference numerals and signs same as those described above represent components same as those explained above.

In FIG. 3B, the heat roller 14 and the coil unit 16 alone superimposed each other are shown. The right and the left in FIG. 3B are respectively a front side and a rear side of the machine body 1a.

The coil 21 has a space 70 in the inner side of a spiral. The space 70 is long in the longitudinal direction of the heat roller 14. The coil 21 may have curved sections 71 at both ends in the longitudinal direction of the heat roller 14. The two curved sections 71 may be curved along a line RR and a line FF.

The magnetic core 22 includes plural core segments arranged in the axis direction. Each of the core segments has plural projecting sections 72. The projecting sections 72 project from the outer side toward the center in the radial direction of the heat roller 14.

The heat roller 14 and the coil 21 hold an insulating material therebetween. The coil 21 and the magnetic core hold an insulating material therebetween. The magnetic core 22 is covered by the insulating material.

The fuser 12 includes a holder 13 between the coil 21 and the heat roller 14. The holder 13 supports the coil 21. An insulating material is used for the holder 13.

The holder 13 prevents the coil 21 from moving in the axis direction at both ends of the holder 13. The holder 13 prevents the coil 21 from moving in a roller radial direction. The holder 13 aligns the coil 21 and the magnetic core 22.

The holder 13 has a pair of pieces 13a at both ends in the axis direction. The gap changing mechanism 17 causes forces in opposite directions along the roller radial direction to act on the pair of pieces 13a.

One force is force in a direction from the holder 13 toward the axis of the heat roller 14. The other force is force in a direction from the axis of the heat roller 14 to the holder 13.

The holder 13, the coil 21, and the magnetic core 22 are fixed by a mold. A thermosetting synthetic resin material is used for the mold. The synthetic resin material is insulative.

One end of the coil 21 is connected to an electric wire 23. The other end of the coil 21 is connected to an electric wire 24. The electric wires 23 and 24 are put together in a plug housing 25. The plug housing 25 has plural contact terminals. High-frequency current is input to the contact terminals.

A Litz wire is used for the coil 21. Plural twisted wire materials insulated from one another are used as the Litz wire. Several tens to several hundreds wire materials are put together in the Litz wire.

Copper is used for the wire materials. The wire materials are covered with heat resistant resin. The resin is polyamideimide. The wire diameter of the wire materials is 0.5 mm. Electric current input to the fuser 12 has a frequency. The wire has smaller diameter to conduct electric current well than depth of penetration at the frequency.

The magnetic core 22 allows a magnetic flux to pass through the magnetic core 22. The magnetic flux leaks to the outside of the magnetic core 22 in the projecting sections 72. The magnetic core 22 causes the leaked magnetic flux to penetrate through the metal conductive layer 14c.

The magnetic core 22 functions as a magnetic circuit configured to efficiently convert current energy into magnetic energy. The magnetic core 22 also functions as a member for blocking magnetism.

The magnetic core 22 changes magnetic properties of the coil 21. The magnetic properties indicate mutual inductance between the metal conductive layer 14c and the Litz wire of the coil 21. The magnetic properties also indicate magnetic permeability.

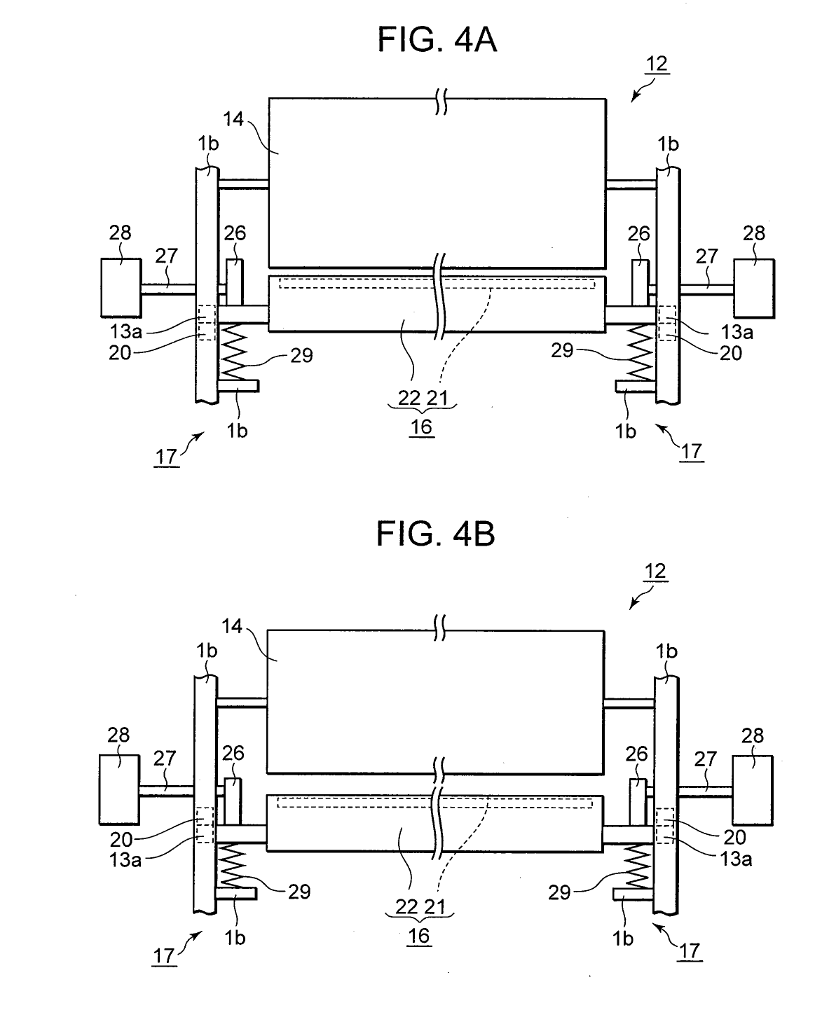

FIGS. 4A and 4B are diagrams of the gap changing mechanism 17. The same reference numerals in the figures denote the same components. Reference numerals and signs same as those described above represent components same as those explained above. The fuser 12 rotatably and movably holds the heat roller 19 on a frame 1b.

The frame 1b indicates a frame of the machine body 1a or the container of the fuser 12. A state in which the gap is narrowed is shown in FIG. 4A. A state in which the gap is widened is shown in FIG. 4B.

The gap changing mechanism 17 changes the clearance of the gap between the heat roller 14 and the coil unit 16.

The gap changing mechanism 17 includes two chambers 20, two pieces 13a, two cams 26, two shafts 27, two motors 28, and two springs 29.

The chambers 20 are provided in the frame 1b. Each of the chambers 20 has walls opposed to each other. One wall regulates each of the pieces 13a from approaching the heat roller 14. The other wall regulates the piece 13a from moving away from the heat roller 14.

The cams 26 are eccentric cams. One motor 28 rotates one cam 26 via one shaft 27. The motor 28 is a DC motor attached with a brush. Torque for rotating the cam 26 is different depending on a rotating position of the cam 26. An electrical board 33 outputs a control signal to the motor 28.

The gap changing mechanism 17 fixes one end of one spring 29 to the frame 1b. The gap changing mechanism 17 brings the other end of the spring 29 into contact with the piece 13a of the coil unit 16. The piece 13a is the resin mold at the end of the coil unit 16.

The other cam 26 and the like are substantially the same as one cam 26 and the like.

The control signal indicates that the gap is narrowed. The motors 28 rotate motor rotors from the present rotating positions to rotating positions where the clearance decreases. The springs 29 apply force, which acts from the coil unit 16 to the heat roller 14, to the coil unit 16. The chambers 20 prevent the movement of the pieces 13a.

The gap changing mechanism 17 brings the coil unit 16 close to the heat roller 14.

The control signal indicates that the gap is expanded. The motors 28 rotate the motor rotors from the present rotating positions to rotating positions where the clearance increases. The coil unit 16 moves away from the heat roller 14 against the elastic force of the springs 29. The chambers 20 prevent the movement of the pieces 13a.

The gap changing mechanism 17 moves the coil unit 16 away from the heat roller 14.

The MFP 1 shown in FIG. 1 includes a main control unit 31 (a controller), a power supply unit 32, and the electrical board 33. The main control unit 31 controls the entire MFP 1. The main control unit 31 controls the MFP 1 in plural modes. The main control unit 31 sets a mode of the MFP 1 to one of the plural modes.

The main control unit 31 generates a print job. The print unit 4 causes the image forming units 4Y, 4M, 4C, and 4K to operate according to the print job.

The main control unit 31 includes a ROM (read only memory) 31a, a RAM (random access memory) 31b, a CPU (central processing unit) 31c, and a mode setting unit 36.

The ROM 31a stores a table configured to associate the modes of the MFP 1 and values of electric power to the fuser 12 with each other. The table associates the modes and values of electric power corresponding to the modes with each other.

The mode setting unit 36 selects any one of the plural modes and allocates the mode to the MFP 1. The CPU 31c functions as the mode setting unit 36. The mode setting unit 36 transitions the mode of the MFP 1 among a print mode, a warming-up mode, a ready mode, and the like.

The print mode indicates a mode in which the MFP 1 runs an image forming process and the temperature of the fuser 12 is fixing temperature.

The warming-up mode is a mode in which the temperature of the fuser 12 is being raised to the fixing temperature.

The ready mode indicates a mode in which the MFP 1 is operable to immediately start the image forming process and the temperature of the fuser 12 is the fixing temperature.

The ready mode is a first mode in which the print unit 4 operates at first power consumption. Both of the print mode and the warming-up mode are a second mode. In the second mode, the print unit 4 operates at second power consumption larger than the first power consumption.

The ROM 31a associates the warming-up mode and a value of electric power. The value is selected from a range of 700 W to 1500 W.

The ROM 31a associates the print mode and a value of electric power. The value is selected from the range of 700 W to 1500 W.

The ROM 31a associates the ready mode and a value of electric power. The value is selected from a range of 200 W to 600 W.

The ROM 31a stores a computer program. The computer program receives the input of the temperature of the heat roller 14 and outputs power level information to the fuser 12. The ROM 31a stores a table. The table associates the modes and time in which electric current is applied to the coil 21 each other.

The RAM 31b stores present mode information of the MFP 1. The RAM 31b is a DRAM (dynamic random access memory), an SRAM (static random access memory), a VRAM (video ram), or the like.

The main control unit 31 sends information indicating a first power level to the driving circuit 44 to instruct the gap changing mechanism 17 to change the clearance to a first distance. The main control unit 31 sends information indicating a second power level larger than the first power level to the driving circuit 44 to instruct the gap changing mechanism 17 to change the clearance to a second distance larger than the first distance.

The power supply unit 32 converts electric power from a commercial AC power supply 37 into plural DC voltages at different levels. The MFP 1 includes the electrical board 33 on an inner side surface of the machine body la. The inner side surface is located on the rear side of the machine body 1a.

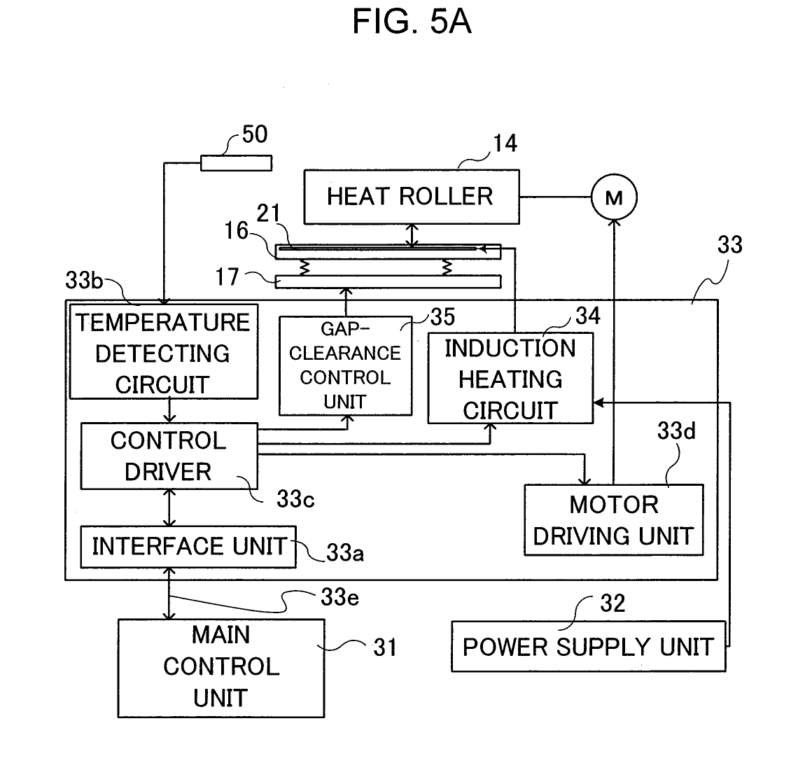

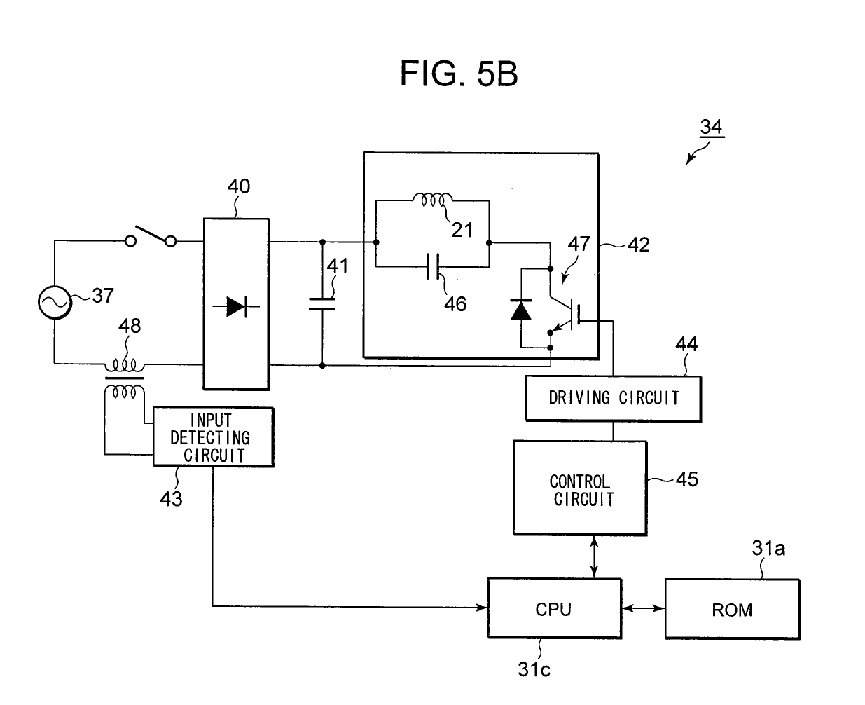

FIG. 5A is a block diagram of circuits on the electrical board 33. Reference numerals and signs same as those described above represent components same as those explained above.

The electrical board 33 includes an induction heating circuit 34 and a gap-clearance control unit 35.

The induction heating circuit 34 applies high-frequency current to the coil unit 16. The induction heating circuit 34 outputs electric power at plural different levels. The induction heating circuit 34 supplies DC voltage, which is supplied from the power supply unit 32, to the coil unit 16.

In the warming-up mode or the print mode, the main control unit 31 causes the induction heating circuit 34 to apply electric power having a value in a range of 700 W to 1500 W to the fuser 12.

In the ready mode, the main control unit 31 causes the induction heating circuit 34 to apply electric power having a value in a range of 200 W to 600 W to the fuser 12. During the ready mode, the gap changing mechanism 17 brings the heat roller 14 and the coil 21 close to each other.

During the warming-up mode or the print mode, the gap changing mechanism 17 moves the heat roller 14 and the coil 21 away from each other.

FIG. 5B is a block diagram of the induction heating circuit 34. Reference numerals and signs same as those described above represent components same as those explained above. The induction heating circuit 34 includes a rectifying circuit 40, a capacitor 41, an inverter circuit 42, an input detecting circuit 43, a driving circuit 44 (a driver), and a control circuit 45.

The rectifying circuit 40 rectifies alternating current from the commercial AC power supply 37. The capacitor 41 smoothes an output of the rectifying circuit 40. The capacitor 41 supplies DC power to the inverter circuit 42.

The inverter circuit 42 includes a coil 21, a capacitor 46, and a switching element 47. The capacitor 46 is connected in parallel to the coil 21.

The switching element 47 is connected in series to a parallel circuit including the coil 21 and the capacitor 46 as a pair. A signal output by the switching element 47 has a resonant frequency. The capacitor 46 and the coil 21 resonate with each other at the resonant frequency.

As a switching element 47, an IGBT (insulated gate bipolar transistor), a MOS-FET (metal-oxide semiconductor field-effect transistor), or the like is used. Withstanding voltage of the IGBT and the MOS-FET is high. Driving current of the IGBT and the MOS-FET is large.

The induction heating circuit 34 includes a transformer 48 at the front end of the rectifying circuit 40.

The input detecting circuit 43 monitors electric power on a secondary side of the transformer 48. The electric power on the secondary side is equivalent to all power consumptions of the fuser 12.

The input detecting circuit 43 feeds back power consumption to the main control unit 31. The input detecting circuit 43 may feed back the power consumption to the main control unit 31 through the control circuit 45.

The driving circuit 44 is connected to a control terminal of the switching element 47. The driving circuit 44 applies driving voltage to the control terminal of the switching element 47. The control terminal turns on the switching element 47.

The control circuit 45 modulates electric current according to a PWM (pulse width modulation) scheme. The control circuit 45 sets a frequency to a value in a range of 20 kHz to 100 kHz. The control circuit 45 changes the frequency and changes the width of a current pulse.

The control circuit 45 controls time in which the switching element 47 continues on and time in which the switching element 47 continues off. The control circuit 45 changes timing when the driving voltage is applied.

In FIG. 5A, the gap-clearance control unit 35 outputs a control signal to the motor 28 and drives the gap changing mechanism 17. An LSI (large scale integration) is used as the gap-clearance control unit 35.

The electrical board 33 includes an interface unit 33a, a temperature detecting circuit 33b, a control driver 33c, and a motor driving unit 33d. The interface unit 33a transmits and receives a signal to and from the main control unit 31 via a signal line 33e. The interface unit 33a is a photo-coupler.

The control driver 33c inputs and outputs a control signal to and from each of the interface unit 33a, the temperature detecting circuit 33b, the gap-clearance control unit 35, the induction heating circuit 34, and the motor driving unit 33d.

The temperature detecting circuit 33b detects the temperature of the heat roller 14. The fuser 12 includes a temperature sensor 50. The temperature sensor 50 is a thermopile.

The temperature sensor 50 comes into contact with neither the heat roller 14 nor the coil unit 16. The temperature sensor 50 does not cross the axis of the heat roller 14.

The temperature sensor 50 outputs a detection signal of temperature. The detection signal is represented by voltage. The temperature detecting circuit 33b notifies the main control unit 31 of the detection signal. According to the output voltage of the temperature sensor 50, the CPU 31c sends, to the control circuit 45, a command for changing the width of a current pulse output by the driving circuit 44.

The motor driving unit 33d drives a motor M. The motor M rotates at least one of the heat roller 14 and the press roller 15.

Referring back to FIG. 1, the MFP 1 includes plural roller pairs 46 in a lower part the machine body 1a. The roller pairs 46 separate sheets one by one and convey the sheet. A roller pair 47 corrects skew of the sheet. The roller pair 47 leads the sheet to the print unit 4.

Nips of the roller pairs 5b, 46, and 47, a guide member, the secondary transfer member 11, and the fuser define a conveying path for the sheet. Motors configured to respectively rotate the roller pairs 5b, 46, and 47, a roller pair in the secondary transfer member 11, the heat roller 14, the press roller 15, and the guide member configure a sheet conveying mechanism.

During the print mode, the sheet conveying mechanism picks up a sheet from the cassettes 5a. The sheet conveying mechanism supplies the sheet into the conveying path. The sheet conveying mechanism conveys the sheet upward in the conveying path.

The print unit 4 forms electrostatic latent images on four photoconductive surfaces on the basis of image data from the scanner unit 2. The mixers in the developing devices 8 agitate toners. The developing rollers supply the toners to the photoconductive members on which the electrostatic latent images are formed. The electrostatic latent images on the photoconductive surfaces are visualized.

Toner images of four colors are transferred onto a belt surface of the belt 10. The secondary transfer member 11 transfers the toner images on the belt 10 onto the sheet.

The fuser 12 heats and presses the sheet. The fuser 12 fixes the toner images of the four colors on the sheet. Other roller pairs convey the sheet, which is output by the fuser 12, through a conveying path in an upper part of the machine body 1a. A discharge tray 65 stores the sheet therein.

The MFP 1 having the configuration explained above is turned on. The mode setting unit 36 sets the mode of the MFP 1 to the warming-up mode.

The gap changing mechanism 17 moves the positions of the heat roller 14 and the coil unit 16 to home positions. The gap changing mechanism 17 drives the cams 26. The gap changing mechanism 17 sets the clearance to a reference distance.

The reference distance indicates, for example, an initial value of the MFP 1 stored in the ROM 31a. The value is set in advance by an experiment, simulation, a test, or the like.

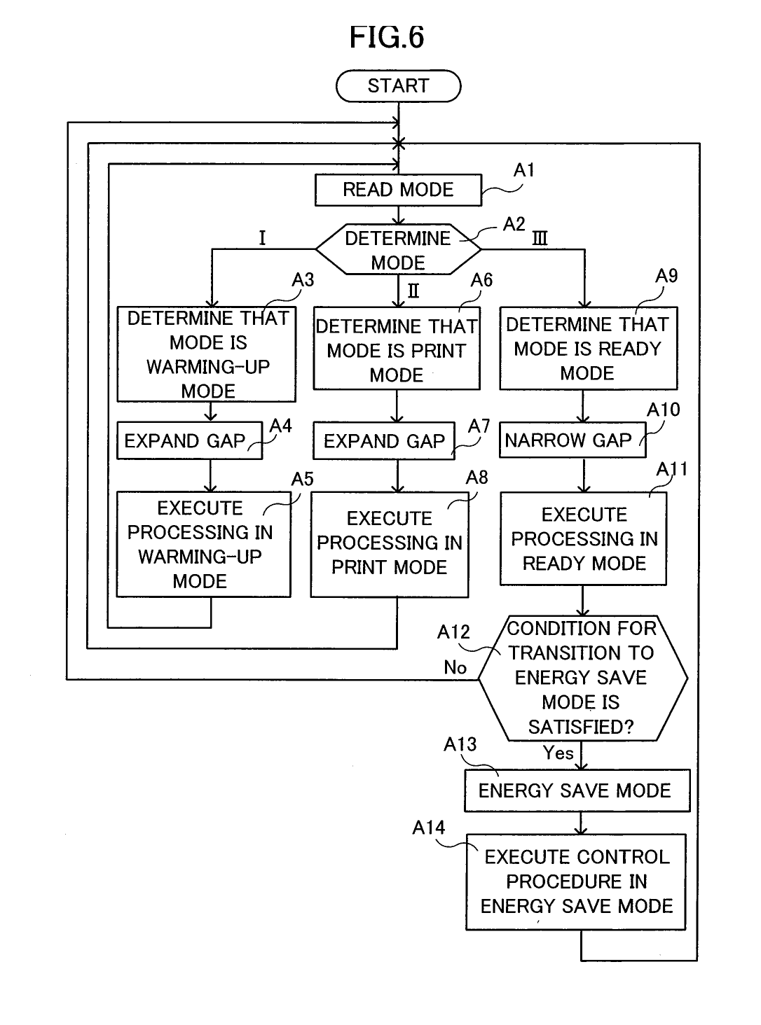

FIG. 6 is a flowchart for explaining a heating control method of the fuser 12. The main control unit 31 executes the method.

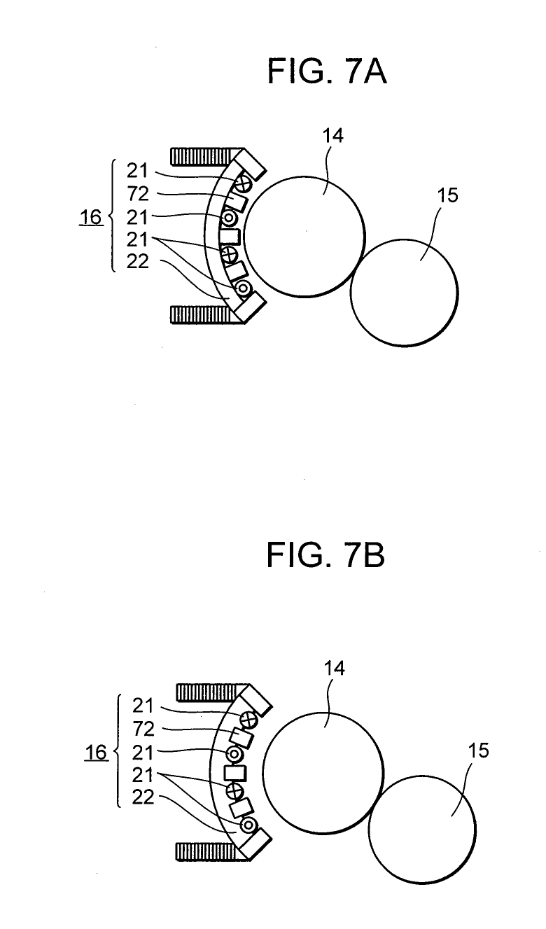

FIG. 7A is a sectional view of the heat roller 14 and the coil unit 16 in a state in which the gap changing mechanism 17 narrows the gap. FIG. 7B is a sectional view of the heat roller 14 and the coil unit 16 in a state in which the gap changing mechanism 17 expands the gap. Reference numerals and signs same as those described above represent components same as those explained above.

In FIGS. 7A and 7B, the holder 13 is omitted.

In Act A1, the main control unit 31 reads a mode of the MFP 1. In Act A2, the main control unit 31 acquires mode information and, through a route I, in Act A3, determines that the mode of the MFP 1 is the warming-up mode.

In Act A4, the main control unit 31 instructs the gap changing mechanism 17 to expand the gap.

The gap changing mechanism 17 moves the coil unit 16 in the home position away from the heat roller 14.

In Act A5, the main control unit 31 executes processing corresponding to the warming-up mode. The main control unit 31 reads a power level from the ROM 31a. The main control unit 31 notifies the induction heating circuit 34 of high-power level information.

The induction heating circuit 34 drives the inverter circuit 42 (an inverter). The fuser 12 drives the coil unit 16 with electric power of 900 W.

The main control unit 31 monitors an output of the temperature sensor 50. The temperature of the fuser 12 reaches set temperature. The main control unit 31 ends the processing in Act A5. The main control unit 31 returns to the processing in Act A1.

A sheet document or a book document is inserted into the scanner unit 2. The mode setting unit 36 writes print mode information in the RAM 31b.

The main control unit 31 reads a mode of the MFP 1 (Act A1). In Act A2, the main control unit 31 acquires mode information and, through a route II, in Act A6, determines that the mode of the MFP 1 is the print mode.

In Act A7, the main control unit 31 instructs the gap changing mechanism 17 to expand the gap.

The gap changing mechanism 17 keeps a gap having a distance larger than the reference distance.

Alternatively, the gap changing mechanism 17 expands a gap having the reference distance.

Alternatively, the gap changing mechanism 17 expands a gap having a distance smaller than the reference distance.

In Act A8, the main control unit 31 executes fixing processing. The main control unit 31 notifies the induction heating circuit 34 of high-power level information. The induction heating circuit 34 drives the inverter circuit 42.

The CPU 31c reads a temperature condition from the table stored in the ROM 31a. The CPU 31c sets a driving frequency on the basis of the temperature condition. The driving frequency has a value in a range of, for example, 20 kHz to 50 kHz.

The inverter circuit 42 switches DC voltage. The coil 21 generates a magnetic field having a value in a range of 700 W to 1500 W in terms of electric power.

A magnetic flux reaches the metal conductive layer 14c of the heat roller 14. The magnetic flux from the surface of the metal conductive layer 14c toward the inside thereof penetrates into the layer. Eddy-current is generated on the surface and cancels the magnetic flux. The eddy-current and metal resistance generate Joule heat. The metal conductive layer 14c generates heat.

The inverter circuit 42 raises the temperature of the heat roller 14 to the fixing temperature. A power level by the magnetic field is enabled to be changed in a range of 700 W to 1500 W.

The change of the power level by the inverter circuit 42 is an instruction for changing a driving frequency given to the driving circuit 44 by the control circuit 45. The fuser 12 heats the coil unit 16 at 900 W.

The main control unit 31 causes the print unit 4 to operate. During fixing, the main control unit 31 controls the fuser 12 to keep the fixing temperature at the set temperature.

After print out, the main control unit 31 transitions the mode of the MFP 1 to the ready mode according to timeout or the like. The main control unit 31 returns to the processing in Act 1. The MFP 1 stays on standby in a state in which the MFP 1 is operable to immediately start printing.

The main control unit 31 reads a mode of the MFP 1 (Act A1). The main control unit 31 acquires mode information (Act A2) and, through a route III, in Act A9, determines that the mode of the MFP 1 is the ready mode.

In Act A10, the main control unit 31 instructs the gap changing mechanism 17 to narrow the gap.

The gap changing mechanism 17 narrows a gap in an expanded state.

Alternatively, the gap changing mechanism 17 narrows a gap having the reference distance.

Alternatively, the gap changing mechanism 17 keeps a gap having a small distance.

In Act A11, the main control unit 31 continues heating. The main control unit 31 notifies the induction heating circuit 34 of low-power level information.

The induction heating circuit 34 changes a frequency and width of a current pulse to the inverter circuit 42.

The induction heating circuit 34 drives the inverter circuit 42 with the current pulse after the change.

The gap changing mechanism 17 narrows the gap to heat the heat roller 14 again by the coil unit 16. The narrowing of the gap quickens resumption of printing by the MFP 1.

In Act A12, the main control unit 31 determines whether a condition for transition to an energy save mode is satisfied. The energy save mode indicates a mode having power consumption smaller than power consumption in the ready mode. The energy save mode indicates a sleep mode or the like. The condition indicates an interrupt or the like due to time-up.

If a determination result is affirmative in Act A12, through a Yes route, in Act A13, the main control unit 31 transitions the mode of the MFP 1 to the energy save mode.

In Act A14, the main control unit 31 executes processing in the energy saving mode. For example, the main control unit 31 notifies the induction heating circuit 34 that the induction heating circuit 34 is turned off. The main control unit 31 interrupts the supply of voltage from the power supply unit 32 to the induction heating circuit 34.

In Act A14, a print job is generated. The main control unit 31 causes processing for returning the mode to the print mode to run. When the print job is generated, the main control unit 31 controls the mode of the fuser 12, for example, in substantially the same manner as the example of the warming-up mode.

The main control unit 31 ends the processing in Act A14 and returns to the processing in Act A1. If a determination result is negative in Act A12, through a No route, the main control unit 31 returns to the processing in Act A1.

The gap is able to be set to an appropriate clearance according to the magnitude of electric power from the induction heating circuit 34. Conversion efficiency of fixing performed by using induction heating is improved. The fuser 12 improves the conversion efficiency with respect to electric power output by the fuser 12.

The foamed rubber 14b is thermally expanded according to the heat generation of the metal conductive layer 14c. The outer diameter of the heat roller 14 at high temperature is large compared with the outer diameter of the heat roller 14 at low temperature.

The fuser 12 controls the clearance such that a magnetic characteristic after the heat generation of the heat roller 14 is not deteriorated from a magnetic characteristic before the heat generation of the heat roller 14. The fuser 12 keeps the clearance at a distance for preventing the magnetic characteristic from being deteriorated with respect to the thermal expansion.

The fuser 12 controls the clearance such that the magnetic characteristic is not deteriorated by an assembly tolerance of the heat roller 14 and the coil unit 16. The assembly tolerance indicates a difference between a maximum and a minimum of the clearance between the heat roller 14 and the coil unit 16 after manufacturing. The fuser 12 keeps the clearance at a distance for preventing the magnetic characteristic from being deteriorated with respect to a worst assembly tolerance.

Even if an outer diameter dimension of the heat roller 14 at high temperature is larger than an outer diameter dimension at low temperature, the fuser 12 is enabled to heat the heat roller 14 without deteriorating the magnetic characteristic.

In a process for attaching the coil 21 and the heat roller 14, a position in the center in an entire range of the attachment in the axis direction is selected as an index of the gap.

Even if the coil 21 and the heat roller 14 are attached without a gap having an appropriate clearance, the fuser 12 changes the clearance according to electric power output by the fuser 12. With the fuser 12, most efficient IH driving can be always performed.

In the fuser 12, the position of the coil unit 16 is not fixed. The fuser 12 with the clearance increased in order to operate at 1500 W does not operate at 200 W.

The fuser 12 does not feed excessively large current to the coil 21. The conversion efficiency is not deteriorated.

As the clearance is smaller, electric current flowing to the coil 21 is smaller. The conversion efficiency is further improved. As the electric current is smaller, electric power supplied to the coil 21 is smaller. The power consumption of the fuser 12 further decreases.

The opposite is the same. As the clearance is larger, the electric power supplied to the coil 21 is larger. The power consumption of the fuser 12 further increases.

For example, the main control unit 31 sets a power level to 1500 W. The gap-clearance control unit 35 causes the gap changing mechanism 17 to set the clearance to 5 mm. The power consumption of the fuser 12 increases. The main control unit 31 sets the power level to 500 W. The gap changing mechanism 17 sets the clearance to 3 mm.

The fuser 12 is operable to set the clearance close to an appropriate distance with respect to the power consumption of the fuser 12.

The gap changing mechanism 17 expands the gap to raise an upper limit of electric power that is inputtable to the control circuit 45. Electric current flowing to circuit elements of the driving circuit 44 increases. The rise in the temperature of the circuit elements increases and the conversion efficiency is deteriorated.

The gap changing mechanism 17 narrows the gap to lower the upper limit of the electric power that is inputtable to the control circuit 45. The electric current flowing to the circuit elements of the driving circuit 44 also decreases. The rise in the temperature of the circuit elements decreases and the conversion efficiency is improved.

When electric power of 500 W is necessary, the fuser 12 changes the clearance to a distance for setting the electric power of 500 W as an upper limit. When electric power of 1500 W is necessary, the fuser 12 changes the clearance to a distance for setting the electric power of 1500 W as an upper limit.

The fuser 12 receives power level information from the main control unit 31. The fuser 12 changes the clearance with respect to the power level information to thereby adjust an upper limit of a power level consumed by the fuser 12 to the power level information.

The fuser 12 controls the clearance such that a clearance for setting a necessary power value as an upper limit can be obtained. The fuser 12 can obtain appropriate conversion efficiency.

According to the first embodiment, the MFP 1 has enough capability to reduce power consumption in a state in which the same heat can be obtained, energy saving can be attained, and the MFP 1 meets the international standard.

### Second Embodiment

The example of the single coil explained above is a best mode. However, plural coils maybe used in the coil unit.

An image forming apparatus according to a second embodiment is also the MFP 1. A fuser according to this embodiment is denoted by reference numeral 51 in FIG. 1.

A heating control method for the fuser according to this embodiment is a method with which the gap changing mechanism 17 changes a clearance between a coil unit and the heat roller 14 according to a power level.

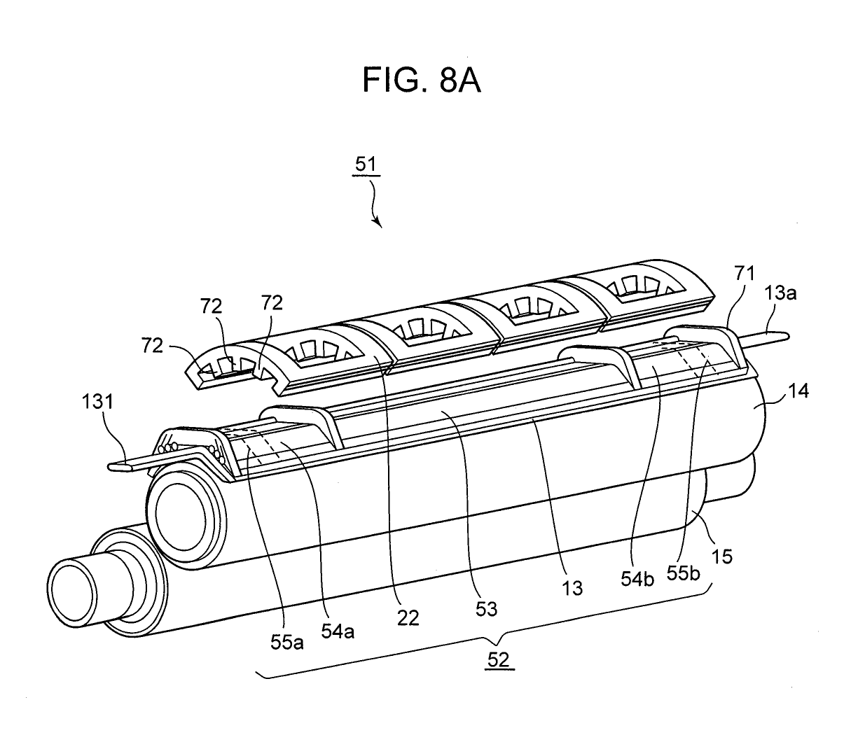

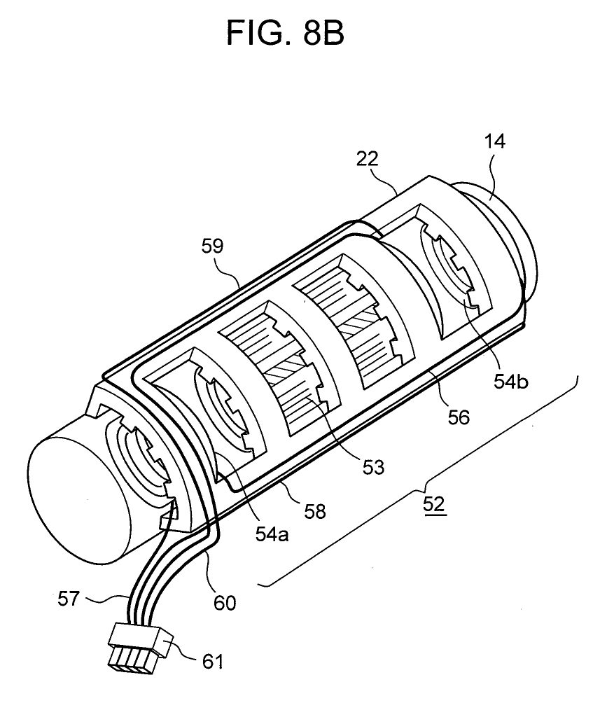

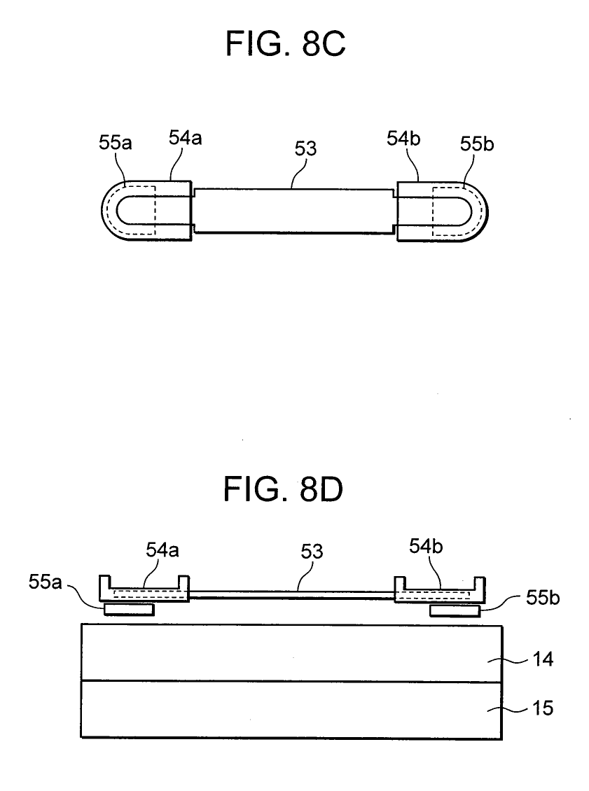

FIG. 8A is a disassembled perspective view of the fuser 51. FIG. 8B is a perspective view of the heat roller 14 and the coil unit. FIGS. 8C and 8D are a top view and a side view of five coils.

In FIGS. 8A to 8D, components denoted by the same reference numerals and signs are the same components. Reference numerals and signs same as those described above represent components same as those explained above. The left and the right in FIG. 8 respectively are the front side and the rear side of the machine body 1a.

The fuser 51 includes a coil unit 52. The coil unit 52 includes one center coil 53, a pair of first side coils 54a and 54b, and a pair of second side coils 55a and 55b.

The coil unit 52 includes the center coil 53 in the center in an axis direction thereof. The coil unit 52 includes the first side coils 54a and 54b on both sides of the center coil 53. The coil unit 52 includes the second side coils 55a and 55b on both the sides of the center coil 53.

The fuser 51 fixes images on plural kinds of sheets having sheet sizes different from one another. The sheet size indicates sheet width in the axis direction or the sheet length in the axis direction.

The center coil 53 heats a sheet having a maximum sheet size. The maximum sheet size indicates maximum sheet width or maximum sheet length.

The first side coils 54a and 54b offset magnetic fluxes at both ends of the center coil 53. The center coil 53 and the first side coils 54a and 54b heat a sheet having a size smaller than the maximum size.

The second side coils 55a and 55b also offset magnetic fluxes at both the ends of the center coil 53. The center coil 53 and the second side coils 55a and 55b heat a sheet having another size smaller than the maximum size.

In some case, the center coil 53, the first side coils 54a and 54b, and the second side coils 55a and 55b are referred to as coils 53, 54a, 54b, 55a, and 55b.

In the coil unit 52, all of the heat roller 14, the coils 53, 54a, 54b, 55a, and 55b, and the magnetic core 22 are fixed by resin molds. The coil unit 52 includes insulators for insulating the coils 53, 54a, 54b, 55a, and 55b from one another. The coil unit 52 has the coils 53, 54a, 54b, 55a, and 55b spaced apart from the outer circumferential surface of the heat roller 14.

Litz wires are used for all the coils 53, 54a, 54b, 55a, and 55b. The number of turns of windings of the Litz wires may be changed in the coils 53, 54a, 54b, 55a, and 55b.

In the coil unit 52, the center coil 53 and the first side coils 54a and 54b are connected by using electric wires 56, 57, 58, 59, and 60. An example of the connection is shown in FIG. 8B. The electric wires 57, 58, 59, and 60 are bound in a plug housing 61. The plug housing 61 is connected to the electrical board 33.

In the coil unit 52, the center coil 53 and the second side coils 55a and 55b are connected in substantially the same manner as the example of the connection relation between the center coil 53 and the first side coils 54a and 54b.

The ROM 31a stores a computer program. The computer program receives the input of the temperature of the heat roller 14 and outputs power level information to the fuser 51.

The ROM 31a stores modes and length of time in which electric current is applied to the coils 53, 54a, 54b, 55a, and 55b in association with each other. The ROM 31a also stores timing when the electric current is applied to the coils 53, 54a, 54b, 55a, and 55b.

The coil unit 52 heats the metal conductive layer 14c with the coils 53, 54a, 54b, 55a, and 55b.

The coil unit 52 feeds electric current to the first side coils 54a and 54b and the center coil 53 such that a phase of a magnetic field generated by the first side coils 54a and 54b is opposite to a phase of a magnetic field generated by the center coil 53.

Alternatively, the coil unit 52 feeds electric current to the second side coils 55a and 55b and the center coil 53 such that a phase of a magnetic field generated by the second side coils 55a and 55b is opposite to the phase of the magnetic field generated by the center coil 53.

A sheet having small sheet width or small sheet length compared with roller length of the heat roller 14 is inserted into the scanner unit 2. The sheet conveying mechanism conveys the sheet to the fuser 51.

The coil unit 52 heats the first side coils 54a and 54b and the second side coils 55a and 55b such that heat at both ends of the heat roller 14 is not deprived by the passage of the sheet. The fuser 51 prevents a temperature rise of the coil unit 52 at both the ends of the heat roller 14.

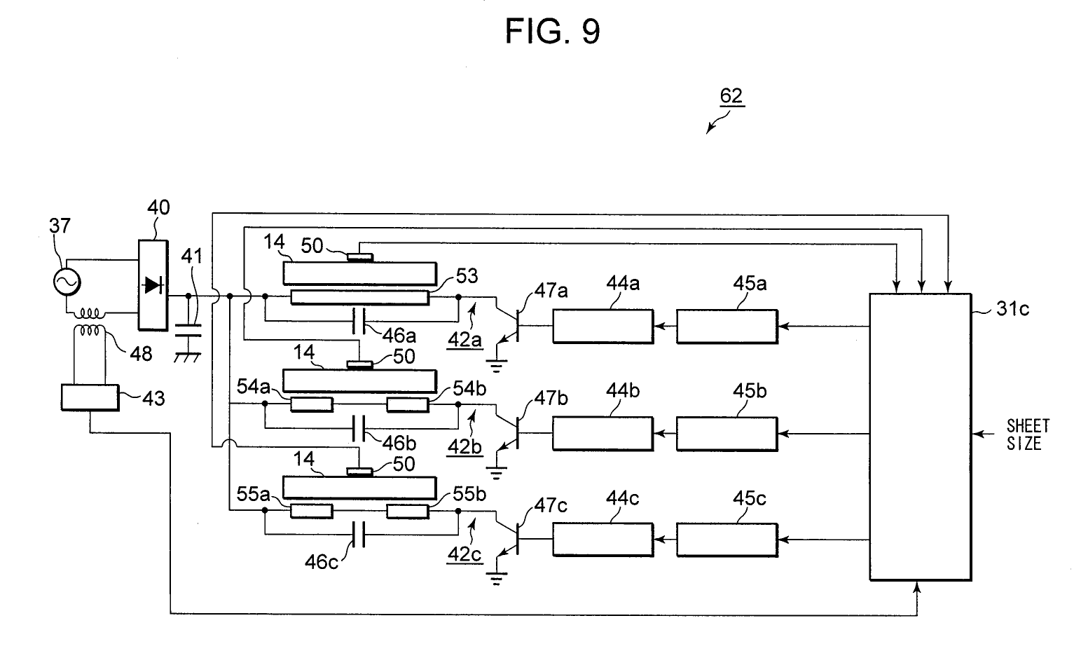

FIG. 9 is a block diagram of an induction heating circuit. Reference numerals and signs same as those described above represents components same as those explained above. In FIG. 9, one heat roller 14 is redundantly drawn.

An induction heating circuit 62 controls temperature detection. The induction heating circuit 62, controls generation of magnetic fluxes by coils. The induction heating circuit 62 controls driving of inverter circuits.

The induction heating circuit 62 includes capacitors 46a, 46b, and 46c. The induction heating circuit 62 includes driving circuits 44a, 44b, and 44c. The induction heating circuit 62 includes control circuits 45a, 45b, and 45c.

The center coil 53, the capacitor 46a, and a switching element 47a configure an inverter circuit 42a. The first side coils 54a and 54b, the capacitor 46b, and a switching element 47b configure an inverter circuit 42b.

The second side coils 55a and 55b, the capacitor 46c, and a switching element 47c configure an inverter circuit 42c.

A signal from the switching element 47a has a resonant frequency. The capacitor 46a and the center coil 53 resonate with each other at the resonant frequency.

A signal from the switching element 47b has a resonant frequency. The capacitor 46b and the first side coils 54a and 54b resonate with each other at the resonant frequency.

A signal from the switching element 47c has a resonant frequency. The capacitor 46c and the second side coils 55a and 55b resonate with each other at the resonant frequency.

As the switching elements 47a, 47b, and 47c, an IGBT, a MOS-FET, or the like is used.

The driving circuits 44a, 44b, and 44c are respectively connected to control terminals of the switching elements 47a, 47b, and 47c.

The driving circuits 49a, 44b, and 44c respectively apply driving voltages to the control terminals of the switching elements 47a, 47b, and 47c. The control terminals respectively turn on the switching elements 47a, 47b, and 47c.

The control circuit 45a sets a frequency to a value in a range of 20 kHz to 100 kHz. The control circuit 45a subjects electric current to pulse width modulation. The control circuit 45a changes the value of the frequency in the range. The control circuit 45a changes the width of a current pulse.

The inverter circuit 42a applies electric current having a frequency in the range of 20 kHz to 100 kHz to the center coil 53. The center coil 53 generates a magnetic flux and eddy-current in the metal conductive layer 14c of the heat roller 14. The eddy-current and a resistance component of the heat roller 14 generate Joule heat. The surface of the heat roller 14 is heated. The center coil 53 changes electric power in a range of 200 W to 1500 W into heat.

Examples of the control circuits 45b and 45c are substantially the same as the control circuit, 45a.

The input detecting circuit 43 detects all power consumptions of the fuser 12. The input detecting circuit 43 feeds back the power consumptions to the main control unit 31.

The fuser 51 includes one temperature sensor 50. One temperature sensor 50 is redundantly drawn in FIG. 9.

The temperature sensor 50 detects temperatures at, for example, eight points according to a time division scheme. The eight points include three points on the surface of the heat roller 14, three points on the surface of the press roller 15, and any other two points on the inner surface side of a container of the fuser 51.

The fuser 51 includes a mirror on the outer side of the press roller 15. The mirror reflects an infrared ray, which is radiated from the press roller 15, to the temperature sensor 50. The temperature sensor 50 detects temperatures of three areas on the surface of the press roller 15. The temperature sensor 50 uses the temperatures of the other two points for comparison.

The temperature sensor 50 notifies the CPU 31c of a temperature detection signal. The temperature detection signal indicates a voltage value.

The CPU 31c selects any one coil or two or more coils among the coils 53, 54a, 54b, 55a, and 55b. The CPU 31c sends a command to the control circuits 45a, 45b, and 45c. The command includes individual power level information of the coils 53, 54a, 54b, 55a, and 55b.

The MFP 1 having the configuration explained above is turned on. The main control unit 31 sets the mode of the MFP 1 to the warming-up mode. The gap changing mechanism 17 sets the clearance to the reference distance.

The main control unit 31 or the electrical board 33 controls heating of the fuser 51 according to a method substantially the same as the example shown in FIG. 6.

In the warming-up mode, in Act A4, the main control unit 31 expands the gap.

In the printing mode, in Act A7, the main control unit 31 expands the gap.

The gap changing mechanism 17 keeps a gap in an expanded state.

Alternatively, the gap changing mechanism 17 expands a gap having the reference distance.

Alternatively, the gap changing mechanism 17 expands a gap having a distance smaller than the reference distance.

In the ready mode, in Act A10, the main control unit 31 narrows the gap.

The gap changing mechanism 17 narrows a gap in an expanded state.

Alternatively, the gap changing mechanism 17 narrows a gap having the reference distance.

Alternatively, the gap changing mechanism 17 keeps a gap having a distance smaller than the reference distance.

The fuser 51 keeps a clearance of a gap between the coils 53, 54a, 54b, 55a, and 55b and the heat roller 14. The fuser 51 keeps the clearance at a distance for preventing a magnetic characteristic from being deteriorated with respect to thermal expansion.

The fuser 51 controls the clearance such that the magnetic characteristic is not deteriorated by an assembly tolerance of the heat roller 14 and the coil unit 52. The fuser 51 keeps the clearance at a distance for preventing the magnetic characteristic from being deteriorated with respect to a worst assembly tolerance.

In a process for attaching the coils 53, 54a, 54b, 55a, and 55b and the heat roller 14, a position in the center in an entire range of the attachment in the axis direction is selected as an index of the gap.

Concerning conversion efficiency, an upper limit of electric power that can be input to the control circuits 45a, 45b, and 45c can be raised by expanding the gap. A rise in the temperatures of the circuit elements increases and the conversion efficiency is deteriorated.

The fuser 51 can lower, by narrowing the gap, the upper limit of the electric power that can be input to the control circuits 45a, 45b, and 45c. The rise in the temperatures of the circuit elements decreases and the conversion efficiency of the fuser 51 is improved.

The fuser 51 changes the clearance with respect to power level information received by the fuser 51 from the main control unit 31 to thereby adjust an upper limit of a power level consumed by the fuser 51 to the power level information.

The fuser 51 controls the clearance such that a clearance for setting a necessary power value as an upper limit can be obtained. The fuser 51 can obtain appropriate conversion efficiency.

### Third Embodiment

Instead of the motor 28 rotating the cam 26, the gap changing mechanism may move, using a pulse motor, the coil unit 16 in the first embodiment to a position for bringing the coil unit 16 close to the heat roller 14 and a position for moving the coil unit 16 away from the heat roller 14.

An image forming apparatus according to a third embodiment is also the MFP 1. A fuser according to this embodiment is denoted by reference numeral 63 in FIG. 1. A heating control method for the fuser according to this embodiment is a method with which the gap changing mechanism changes a clearance according to an electric power.

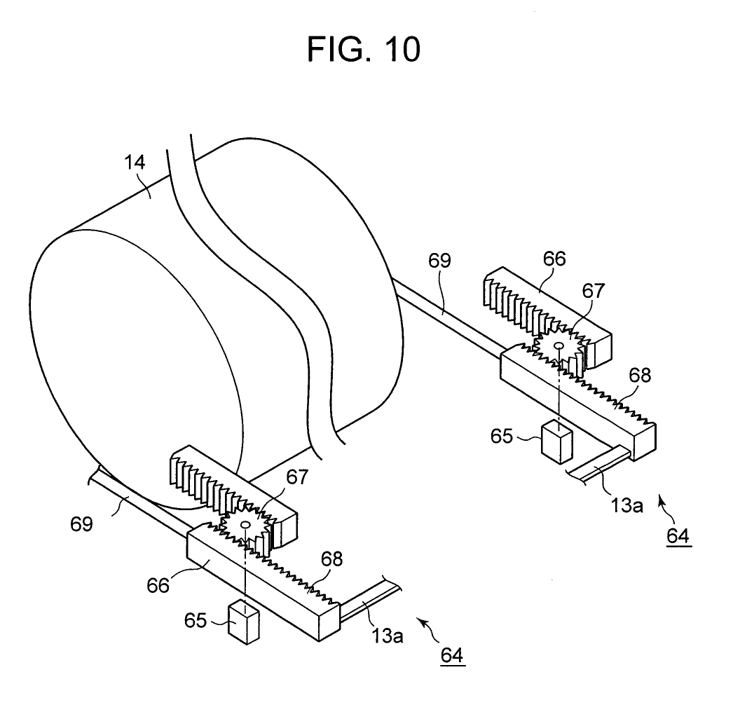

FIG. 10 is a perspective view of a main part of a gap changing mechanism of the fuser 63 according to the third embodiment. Reference numerals and signs same as those described above represent components same as those explained above.

A gap changing mechanism 64 includes two motors 65, two first rack gears 66, two pinion gears 67, and two second rack gears 68.

The motors 65 are pulse motors. The pulse motors rotate the pinion gears 67 by a rotation angle corresponding to the number of pulses. The electrical board 33 outputs a control signal to the motors 65.

The first rack gears 66 have the same height with respect to a floor surface. The gap changing mechanism 64 holds the first rack gears 66 horizontally or with inclination.

The pinion gears 67 mesh with the first rack gears 66. The pinion gears 67 mesh with the second rack gears 68. The second rack gears 68 are respectively guided by rods 69.

The electrical board 33 outputs a control signal to the motors 65. The electrical board 33 rotates all the motors 65 clockwise. The gap changing mechanism 64 rotates the motors 65 by an angle that depends on the number of pulses.

One motor 65 moves, with the pinion gear 67, the second rack gear 68 toward the heat roller 14. The gap changing mechanism 64 brings the piece 13a close to the outer circumferential surface of the heat roller 14. Examples of the other motor 65 and the like are substantially the same as the examples of one motor 65 and the like.

As shown in FIG. 7A, the gap changing mechanism 64 narrows the gap according to a control signal from the main control unit 31.

The electrical board 33 rotates all the motors 65 counterclockwise. One motor 65 moves the second rack gear 68 in a direction away from the outer circumferential surface of the heat roller 14. The gap changing mechanism 64 moves the piece 13a horizontally away from the outer circumferential surface. Examples of the other motor 65 and the like are substantially the same as the examples of one motor 65 and the like.

As shown in FIG. 7B, the gap changing mechanism 64 expands the gap according to a control signal from the main control unit 31.

In the gap changing mechanism 64, the coil unit 52 in the second embodiment may be used.

The gap changing mechanism 64 changes the gap according to a mode of the MFP 1 having the configuration explained above.

The main control unit 31 or the electrical board 33 controls heating of the fuser 51 with a method substantially the same as the example shown in FIG. 6.

Electric power required by the motor with brush to narrow a gap of a clearance is larger than electric power required by the pulse motor to narrow the same clearance. This is because the gap changing mechanism 17 in the first embodiment has the springs 29.

The motor with brush and the pulse motor reduce the same clearance and receive supply of the same electric power.

A motor size of the pulse motor required for outputting rotation torque is smaller than a motor size of the motor with brush required for outputting the same rotation torque. Therefore, the gap changing mechanism 64 can be reduced in size.

### Fourth Embodiment

In a fuser according to a fourth embodiment, a coil unit may be provided on the inside of the heat roller 14.

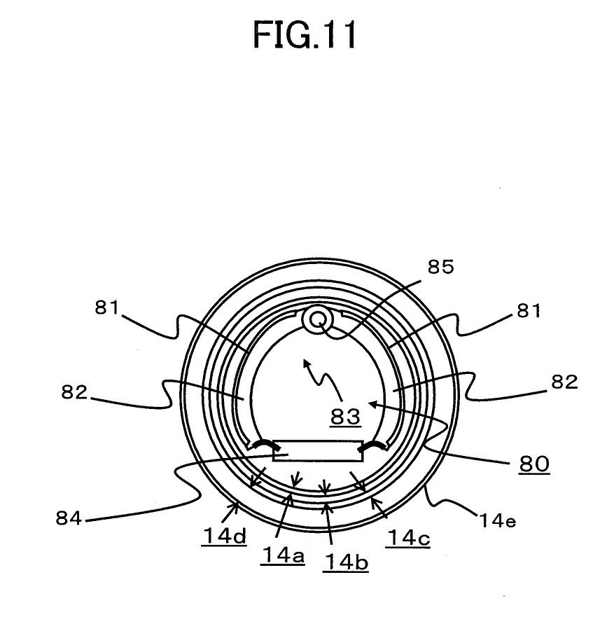

FIG. 11 is a diagram of the arrangement of the fuser according to the fourth embodiment. A coil unit 80 includes two coils 81, two magnetic cores 82, and a gap changing mechanism 83 on the inner side of the core bar 14a.

The coil unit 80 includes the coils 81 opposed to each other. The coil unit 80 includes the coils 81 on the magnetic cores 82. Of two surfaces of each of the magnetic cores 82, the coil unit 80 includes the coil 81 on a surface on the inner surface side of the core bar 14a.

An actuator 84 may be used as a power source for the gap changing mechanism 83. In the gap changing mechanism 83, the actuator 84 is coupled to one ends of the magnetic cores 82. The gap changing mechanism 83 has a pin 85 at the other ends of the magnetic cores 82. The main control unit 31 controls the actuator 84.

The actuator 84 shrinks. Clearances between the two coils 81 and a gap on the inner surface of the core bar 14a increase.

The actuator 84 expands. The clearances between the two coils 81 and the gap on the inner surface of the core bar 14a decrease.

The fuser according to this embodiment receives power level information from the main control unit 31. The fuser changes the clearances with respect to the power level information to thereby adjust an upper limit of a power level consumed by the fuser to the power level information.

As the coils 81, anyone of a single coil and a triple coil can be used.

### Other Embodiments

The gap changing mechanisms 17 and 64 are motor-driven. However, for the gap changing mechanisms 17 and 64, two actuators maybe used as power sources. The electrical board 33 outputs a control signal to the actuators.

The MFP 1 can include another mode having power consumption larger than power consumptions in the warming-up mode and the print mode. A type of the mode can be changed. The superiority of the image forming apparatus is not spoiled at all over an embodiment that is merely carried out by using another mode substantially the same as the ready mode or the like and having a mode name different from the ready mode or the like.

The fuser 51 controls the gap according to three kinds of clearance, i.e., standard, narrow, and wide. However, the fuser 51 may control the gap according to four or more kinds of clearance. The gap changing mechanism 17 may continuously change the clearance. The continuous change of the clearance means that the clearance is changed at a fixed step such as 1 mm.

In the second embodiment, in the coil unit 52, both the ends of the center coil 53 and the first side coils 54a and 54b may be crossed. The coil unit 52 may include the second side coil 55a below or above the first side coil 54a. The coil unit 52 may include the second side coil 55b blow or above the first side coil 54b.

In the second embodiment, the fuser 51 may include five or more sets of coils. A set of coils may be added according to a sheet size. The coil arrangement may be changed according to the sheet size.

In the heating control method for the fuser, the clearance may be changed according to inner temperature of the fuser 51.

Alternatively, in the method, the clearance may be changed according to a mode of the MFP 1.

While certain embodiments have been described, these embodiments have been presented by way of example only, and are not intended to limit the scope of the inventions. Indeed, the novel methods and apparatus described herein may be embodied in a variety of other forms; furthermore various omissions and substitutions and changes in the form of methods and apparatus described herein may be made without departing from the sprit of the inventions. The accompanying claims and their equivalents are intended to cover such forms or modifications as would fall within the scope and sprits of the inventions.

What is claimed is:

1. A fuser comprising:
a heat roller configured to generate heat with a magnetic flux;
a press roller configured to apply pressure to a sheet in cooperation with the heat roller;
a coil configured to generate the magnetic flux to the heat roller;
an inverter configured to supply a driving signal to the coil;
a driver configured to set a power level in the inverter;
a mechanism configured to move the coil and change a clearance of a gap between the coil and an outer circumferential surface of the heat roller; and
a controller configured to send information indicating a first power level to the driver to instruct the mechanism to change the clearance to a first distance and send information indicating a second power level larger than the first power level to the driver to instruct the mechanism to change the clearance to a second distance larger than the first distance.

2. The device according to claim 1, wherein the controller sends information indicating, of a relatively low power level and a relatively high power level, the low power level to the driver to narrow the clearance to be smaller than a reference distance and sends information indicating the high power level to the driver to expand the clearance to be larger than the reference distance.

3. The device according to claim 1, wherein the controller changes the clearance according to given power level information and adjusting an upper limit of a level of electric power consumed by the inverter to the power level information.

4. The device according to claim 3, wherein the controller changes the clearance to the first distance to set the upper limit of the level of the electric power at the first distance to the first power level and changes the clearance to the second distance to set the upper limit of the level of the electric power at the second distance to the second power level.

5. The device according to claim 1, wherein the controller changes the clearance according to a mode of operation of the device.

6. The device according to claim 3, wherein the controller changes the clearance according to the power level information that is different depending on a mode of operation of the device.

7. The device according to claim 1, further comprising a heat generating member in the heat roller and a core configured to concentrate the magnetic flux from the coil on the heat generating member, wherein
the instruction to the mechanism by the controller is an instruction to change a magnetic characteristic of an inductance component between the heat generating member and the coil.

8. An image forming apparatus comprising:
a print unit configured to form an unfixed developer image on a sheet;
a heat roller configured to generate heat with a magnetic flux;
a press roller configured to apply pressure to a sheet in cooperation with the heat roller;
a coil configured to generate the magnetic flux to the heat roller;
an inverter configured to supply a driving signal to the coil;
a driver configured to set a power level in the inverter;
a mechanism configured to move the coil and change a clearance of a gap between the coil and an outer circumferential surface of the heat roller;
a mode setting unit configured to set any one of plural modes including a first mode in which the apparatus operates at first power consumption and a second mode in which the apparatus operates at second power consumption larger than the first power consumption; and
a controller configured to send, during the first mode, information indicating a first power level to the driver to instruct the mechanism to change the clearance to a first distance and send, during the second mode, information indicating a second power level larger than the first power level to the driver to instruct the mechanism to change the clearance to a second distance larger than the first distance.

9. The apparatus according to claim 8, wherein the controller sends information indicating, of a relatively low power level and a relatively high power level, the low power level to the driver to narrow the clearance to be smaller than a reference distance and sends information indicating the high power level to the driver to expand the clearance to be larger than the reference distance.

10. The apparatus according to claim 8, wherein the controller changes the clearance according to power level information given from the mode setting unit and adjusts an upper limit of a level of electric power consumed by the inverter to the power level information.

11. The apparatus according to claim 8, wherein the controller changes the clearance according to a mode of operation of the apparatus.

12. The apparatus according to claim 10, wherein the controller changes the clearance according to the power level information that is different depending on a mode of operation of the apparatus.

13. A method of controlling heating of a fuser, comprising:
setting a first power level in an inverter configured to supply a driving signal to a coil configured to generate a magnetic flux;
changing, according to movement of the coil, a clearance of a gap between an outer circumferential surface of a heat roller configured to generate heat with the magnetic flux and the coil, to a first distance to heat the heat roller;
setting a second power level larger than the first power level in the inverter; and
changing, according to the movement of the coil, the clearance to a second distance larger than the first distance to heat the heat roller.

14. The method according to claim 13, further comprising:
setting the first power level according to information indicating, of a relatively low power level and a relatively high power level, the low power level;
narrowing the clearance to be smaller than a reference distance;
setting the second power level according to information indicating the high power level; and
expanding the clearance to be larger than the reference distance.

15. The method according to claim 13, further comprising changing the clearance according to given power level information to adjust an upper limit of a level of electric power consumed by the inverter to the power level information.

16. The method according to claim 15, further comprising changing the clearance to the first distance to set the upper limit of the level of the electric power at the first distance to the first power level and changing the clearance to the second distance to set the upper limit of the level of the electric power at the second distance to the second power level.

17. The method according to claim 13, further comprising changing the clearance according to a mode of operation of the fuser.

18. The method according to claim 15, further comprising changing the clearance according to the power level information that is different depending on a mode of operation of the fuser.

19. The method according to claim 13, further comprising changing the clearance such that a magnetic characteristic of an inductance component between a heat generating member in the heat roller and the coil after the heat generating member generates heat, is substantially equal to or more excellent than the magnetic characteristic before the heat generating member generates heat.

20. The method according to claim 13, further comprising changing the clearance such that a magnetic characteristic of an inductance component between a heat generating member in the heat roller and the coil is substantially equal to or more excellent than the magnetic characteristic due to a worst value of an assembly tolerance of the heat roller and the coil.
